(19) United States
(12) Patent Application Publication
(10) Pub. No.: US 2023/0417559 A1
(43) Pub. Date: Dec. 28, 2023

(54) METHOD, APPARATUS, AND SYSTEM FOR DETECTING ROAD OBSTRUCTION INTENSITY FOR ROUTING OR MAPPING

(71) Applicant: HERE Global B.V., Eindhoven (NL)

(72) Inventor: Amarnath NAYAK, Mumbai (IN)

(21) Appl. No.: 17/849,318

(22) Filed: Jun. 24, 2022

(51) Int. Cl. G01C 21/34; B60W 60/00; G01C 21/36; B60W 40/04; G08G 1/09; G08G 1/0968; G01C 21/00

(52) U.S. Cl. CPC G01C 21/3415; G01C 21/3461; B60W 60/001; G01C 21/3691; B60W 40/04; G08G 1/091; G08G 1/096827; G01C 21/3815; G01C 21/3841

(57) ABSTRACT

An approach is provided for detecting road obstruction intensity for location-based applications and services. The approach involves, for instance, collecting probe data associated with a road segment. The approach also involves processing the probe data to generate a time space diagram (TSD). The TSD plots the probe data according to distance from an origin point on the road segment over time. The approach further involves determining an intensity of the road obstruction based on the TSD. The approach further involves determining a diversion confidence for diverting a route from the road segment based on the intensity and providing the diversion confidence as an output.

### BACKGROUND

Mapping and navigation service providers face significant technical challenges with respect to determining and mapping dynamic conditions within road network. One particular challenge is with respect to determining not only the presence of road obstructions on a road network, but also the intensity of the effects of the road obstruction on traffic through affected road segments. Accordingly, mapping and navigation service providers continue to develop technical solutions to detect and quantify the intensity of road obstructions dynamically occurring in a road network.

### SOME EXAMPLE EMBODIMENTS

Therefore, there is a need for detecting road obstruction intensity for routing or mapping (e.g., to support autonomous vehicle operation or other routing/mapping applications).

According to one embodiment, a method comprises receiving probe data associated with a road segment. The method also comprises processing the probe data to generate a time space diagram (TSD). By way of example, the TSD plots the probe data according to distance from an origin point on the road segment over time. The method further comprises determining an intensity of the road obstruction based on the TSD. The method further comprises determining a diversion confidence for diverting a route from the road segment based on the intensity and providing the diversion confidence as an output.

According to another embodiment, an apparatus comprises at least one processor, and at least one memory including computer program code for one or more computer programs, the at least one memory and the computer program code configured to, with the at least one processor, cause, at least in part, the apparatus to receive probe data associated with a road segment. The apparatus is also caused to process the probe data to generate a TSD. By way of example, the TSD plots the probe data according to distance from an origin point on the road segment over time. The apparatus is further caused to determine an intensity of the road obstruction based on the TSD. The apparatus is further caused to determine a diversion confidence for diverting a route from the road segment based on the intensity and provide the diversion confidence as an output.

According to another embodiment, a non-transitory computer-readable storage medium carries one or more sequences of one or more instructions which, when executed by one or more processors, cause, at least in part, an apparatus to receive probe data associated with a road segment. The apparatus is also caused to process the probe data to generate a TSD. By way of example, the TSD plots the probe data according to distance from an origin point on the road segment over time. The apparatus is further caused to determine an intensity of the road obstruction based on the TSD. The apparatus is further caused to determine a diversion confidence for diverting a route from the road segment based on the intensity and provide the diversion confidence as an output.

According to another embodiment, an apparatus comprises means for receiving probe data associated with a road segment. The apparatus also comprises means for processing the probe data to generate a TSD. By way of example, the TSD plots the probe data according to distance from an origin point on the road segment over time. The apparatus further comprises means for determining an intensity of the road obstruction based on the TSD. The apparatus further comprises means for determining a diversion confidence for diverting a route from the road segment based on the intensity and means for providing the diversion confidence as an output.

In addition, for various example embodiments described herein, the following is applicable: a computer program product may be provided. For example, a computer program product comprising instructions which, when the program is executed by a computer, cause the computer to perform any one or any combination of methods (or processes) disclosed.

In addition, for various example embodiments described herein, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application.

For various example embodiments described herein, the following is also applicable: a method comprising facilitating access to at least one interface configured to allow access to at least one service, the at least one service configured to perform any one method/process or any combination of network or service provider methods (or processes) disclosed in this application.

For various example embodiments described herein, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application.

For various example embodiments described herein, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of detecting road obstruction intensity for routing or mapping, according to one embodiment;

FIG. 2 is a diagram of components of a mapping platform capable of detecting road obstruction intensity for routing or mapping, according to one embodiment;

FIG. 3 is a flowchart of a process for detecting road obstruction intensity for routing or mapping, according to one embodiment;

FIG. 4 is a diagram illustrating an example time space diagram (TSD), according to one embodiment;

FIGS. 5A-5D are diagrams illustrating example TSDs representing road obstructions of varying intensities, according to various embodiments;

FIGS. 6A-6B are diagrams illustrating examples of using road obstruction intensity data for routing or mapping, according to various embodiments;

FIG. 6C is a diagram illustrating an example mapping user interface based on diversion confidence data, according to one embodiment;

FIG. 7 is a diagram of a geographic database, according to one embodiment;

FIG. 8 is a diagram of hardware that can be used to implement an embodiment of the processes described herein;

FIG. 9 is a diagram of a chip set that can be used to implement an embodiment of the processes described herein; and

FIG. 10 is a diagram of a terminal that can be used to implement an embodiment of the processes described herein.

### DESCRIPTION OF SOME EMBODIMENTS

Examples of a method, apparatus, and computer program for detecting road obstruction intensity for routing or mapping are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. In addition, the embodiments described herein are provided by example, and as such can also “one embodiment” is used synonymously as “one example embodiment.” Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

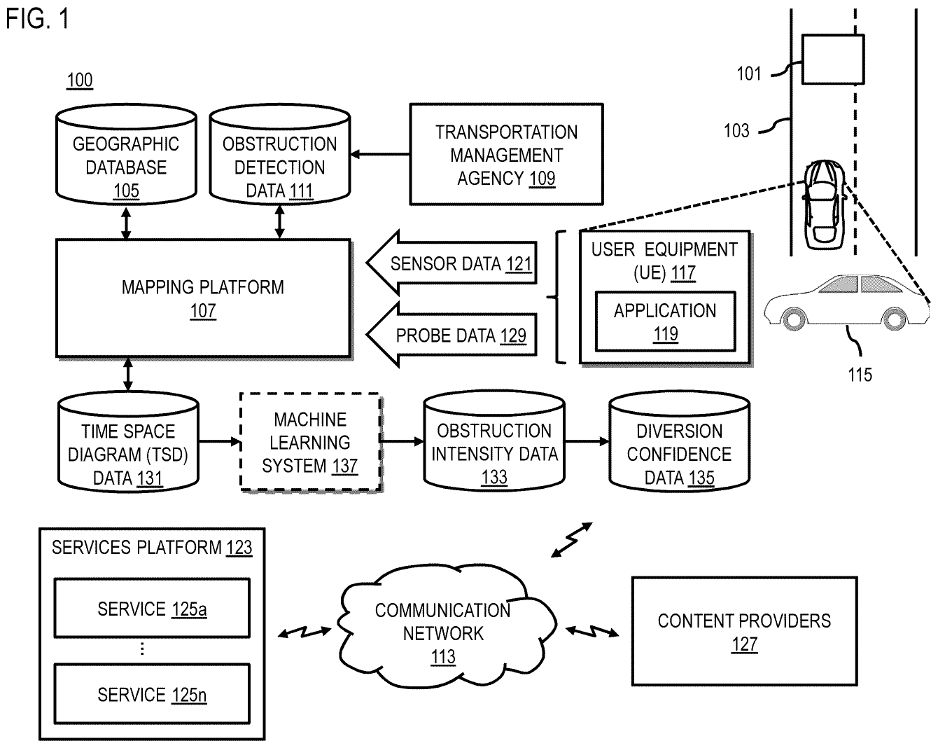

FIG. 1 is a diagram of a system 100 capable of detecting road obstruction intensity for routing or mapping, according to one embodiment. In the areas of autonomous driving, navigation, and mapping, knowing when and where a road obstruction 101 occurs on a road or road segment 103 plays a critical role for traffic flow management. As used herein, the term “road obstruction” refers to any object, condition, or situation occurring on a road (e.g., on road segment 103) that reduces traffic flow below a free flow state or that increases traffic volume above a historical traffic volume of a road segment of interest. In one embodiment, the road segment can be specified as one or more road links represented in a geographic database 105.

In one embodiment, road obstructions 101 can reported to and/or detected by a mapping platform 107. For example, a transportation management agency 109 (e.g., a public department of transportation or equivalent agency) may can transmit obstruction detection data 111 (e.g., records indicating observed road obstructions along with their location, time, type, and/or other similar characteristics) to the mapping platform 107 or other components of the system 100 over a communication network 113. In addition or alternatively, one or more vehicles 115 and/or one or more user equipment devices 117 (e.g., executing corresponding software applications 119) can use onboard sensors (e.g., cameras, LIDAR, RADAR, and/or the like) to collect or otherwise receive sensor data 121 that can be processed to detect and report the road obstruction 101 to the mapping platform 107. In yet another embodiment, other service providers (e.g., a services platform 123 comprising one or more services 125a-125n—also collectively referred to as services 125, content providers 127, etc.), can provide road obstruction detection data 111 to the mapping platform 107.

However, traditional obstruction detection data 111 provides information only on the presence or absence of a road obstruction 101, while applications such as autonomous driving and/or other similar location-based applications may need more detail about the road obstruction 101 such as the intensity of the road obstruction to provide improved or more efficient routing and/or mapping (e.g., by diverting around road obstructions 101 if the intensity of the obstruction is above a threshold value).

To address these technical challenges, the system 100 of FIG. 1 introduces a capability to determine the intensity of a road obstruction 101 with respect to its effect on traffic on a road segment, and then determine a diversion confidence representing a confidence value that an approach vehicle 115 (e.g., an autonomous vehicle or any other vehicle) should or should not divert to an alternative route around the affected road segment 103. In other words, determining accurate road obstruction intensity data, for instance, enables mapping and navigation service providers to provide more reliable routing recommendations about whether to divert vehicles around detected road obstructions, particularly when the vehicle is an autonomous vehicle or otherwise operating in autonomous mode.

In one embodiment, the system 100 (e.g., via the mapping platform 107) collects or otherwise receives probe data 129 from one or more vehicles 115 traveling on the road segment of interest (e.g., a monitored road segment, or a road segment on which a road obstruction 101 has been detected). The probe data 129, for instance, comprises one or more probe points associated with an individual probe device (e.g., vehicle 115 and/or UE 117). The probe points include elements such as but not limited to: (1) geocoordinates (latitude, longitude) determined by a location sensor (e.g., GPS/GNSS or equivalent) of the probe device, (2) time stamp when the geocoordinates were determined, and (3) unique probe identifier associated with the probe device. By sequencing the probe point in time for each unique probe identifier or probe device, the system 100 can obtain a corresponding trajectory of the probe device through the road segment of interest. In one embodiment, the probe points can also include additional data items such as but not limited to heading and speed. In other embodiments, the heading and speed can be calculated from any two successive probe point in a trajectory.

The system 100 then plots the collected or received probe data 129 in a time-space diagram (TSD) to generate TSD data 131. The TSD data 131, for instance, plots the probe data according to distance from an origin point on the road segment instance over time for each unique trajectory in the collected or received probe data 129. The TSD data 131 enables visualization and analysis of the duration and extent on the road segment of the traffic effects of a road obstruction 101. In one embodiment, the duration and/or extent of the road obstruction 101 on the road segment 103 represents the intensity (e.g., obstruction intensity data 133) of the road obstruction 101. For example, road obstructions 101 that affect traffic over a lesser extent and/or lesser duration of the affected road segments 103 will have a lower intensity. Conversely, road obstructions 101 that affect traffic over a greater extent and/or greater duration of the affected road segments 103 will have a higher intensity.

In one embodiment, the system 100 can determine or calculate a diversion confidence (diversion confidence data 135) based on the intensity of the road obstruction 101 determined from the TSD data 131. The diversion confidence, for instance, represents a confidence level that a vehicle 115 approaching a road segment 103 affected by a road obstruction 101 with a given road obstruction intensity should divert to another route and avoid traveling through the affected segment 103.

In one embodiment, the obstruction intensity data 133 and/or diversion confidence data 135 can optionally be determined by using a trained machine learning system 137 to predict obstruction intensity data 133 and/or diversion confidence data 135 from the TSD data 131. For example, the trained machine learning system 137 can be a convolutional neural network that is trained to input TSD data 131 as image-like inputs. In this case, the TSD for a given road obstruction 101 and road segment 103 can be converted into an image of a size and/or resolution compatible with the machine learning system 137. The trained machine learning system 137 can then output an intensity classification (e.g., obstruction intensity data 133) from the input TSD for use in calculating the diversion confidence data 135 and/or directly output the predicted diversion confidence data 135.

In one embodiment, the output of the system 100 (e.g., the diversion confidence data 135) can be used for location-based applications such as but not limited to autonomous driving, routing, mapping, etc. For example, with respect to autonomous driving, the diversion confidence data 135 can be used by a control system of the autonomous vehicle 115 to determine whether to automatically divert from a road segment 103 with a road obstruction. In one embodiment, the control system can be configured apply a diversion confidence threshold to the calculated diversion confidence for a given road obstruction 101 and road segment 103. If the calculated diversion confidence is above the diversion confidence threshold, then the autonomous vehicle 115 will automatically take another route that does not include the affected road segment 103. If the calculated diversion confidence is below the diversion confidence threshold, then the autonomous vehicle 115 will automatically take a route that includes the affected road segment 103 and not divert.

It is contemplated that embodiments described herein are applicable to any type of autonomous vehicle. In the Society of Automotive Engineers' (SAE's) autonomy level definitions, there are six levels of driving automation from 0 to 5 shown as below.
Level 0: Automated system issues warnings and may momentarily intervene but has no sustained vehicle control.
Level 1 (“hands on”): The driver and the automated system share control of the vehicle. Examples are Adaptive Cruise Control (ACC), where the driver controls steering and the automated system controls speed; and Parking Assistance, where steering is automated while speed is manual. The driver must be ready to retake full control at any time. Lane Keeping Assistance (LKA) Type II is a further example of level 1 self-driving.
Level 2 (“hands off”): The automated system takes full control of the vehicle (accelerating, braking, and steering). The driver must monitor the driving and be prepared to intervene immediately at any time if the automated system fails to respond properly. The shorthand “hands off” is not meant to be taken literally. In fact, contact between hand and wheel is often mandatory during SAE 2 driving, to confirm that the driver is ready to intervene.
Level 3 (“eyes off”): The driver can safely turn their attention away from the driving tasks, e.g., the driver can text or watch a movie. The vehicle will handle situations that call for an immediate response, like emergency braking. The driver must still be prepared to intervene within some limited time, specified by the manufacturer, when called upon by the vehicle to do so. The 2018 Audi A8 Luxury Sedan was the first commercial car to claim to be capable of level 3 self-driving. The car has a so-called Traffic Jam Pilot. When activated by the human driver, the car takes full control of all aspects of driving in slow-moving traffic at up to 60 kilometers per hour. The function works only on highways with a physical barrier separating one stream of traffic from oncoming traffic.
Level 4 (“mind off”): As level 3, but no driver attention is ever required for safety, i.e., the driver may safely go to sleep or leave the driver's seat. Self-driving is supported only in limited spatial areas (geofenced) or under special circumstances, like traffic jams. Outside of these areas or circumstances, the vehicle must be able to safely abort the trip, i.e., park the car, if the driver does not retake control.
Level 5 (“steering wheel optional”): No human intervention is required. An example would be a robotic taxi.

As described above, a level 4 vehicle would be driverless in most scenarios and a level 5 vehicle is fully non-human involved vehicles. It is contemplated that the various embodiments described herein are applicable to any of the levels described above.

In one embodiment, a 5G network (or any other equivalent high-speed and low-latency wireless network) plays as the important foundation for autonomous driving. It is expected in the future, autonomous vehicles 115 will be everywhere on the road and even safer than current human drivers given their advanced environment sensing capabilities by the development of machine learning models (e.g., as part of a machine learning system 137 operating in the vehicle 115/UE 117 or remotely of a cloud component such as the mapping platform 107) over different kinds of sensor technologies (e.g., camera, radar, Lidar, etc.), vehicle to vehicle (v2v) communications, and vehicle to infrastructure (v2x) communications. These v2v and v2x can be supported by any communication network 113 with low-latency, high capacity, high bandwidth throughput, and high coverage such as but not limited to 5G. All these scenarios generally enable data processing and communications to the backend server (e.g., mapping platform 107, services platform 123, and/or the like) and from the backend server to the vehicle 115 and/or adjacent vehicles. Accordingly, in one embodiment, the obstruction intensity data 133 and/or diversion confidence data 135 can be computed by the mapping platform 107 and/or vehicle 115/UE 117 and then transmitted to any other component of vehicle 115/UE 117 of the system 100. In addition, alert messages indicating the obstruction intensity data 133 and/or diversion confidence data 135 can also be communicate between components and/or vehicles 115/UE 117 of the system 100.

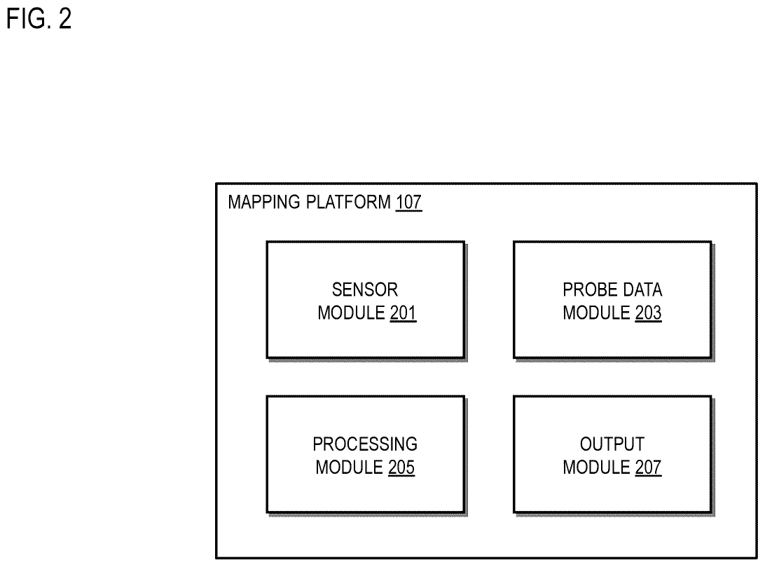

FIG. 2 is a diagram of components of the mapping platform 107 capable of detecting road obstruction intensity for routing or mapping, according to one embodiment. In one embodiment, as shown in FIG. 2, the mapping platform 107 of the system 100 includes one or more components for detecting the intensity of road obstructions for routing or mapping according to the various embodiments described herein. It is contemplated that the functions of the components of the mapping platform 107 may be combined or performed by other components of equivalent functionality. As shown, in one embodiment, the mapping platform 107 includes a sensor module 201 (e.g., for determining or receiving road obstruction detection data 111), a probe data module 203 (e.g., for collecting or receiving probe data 129 for generating TSD data 131), processing module 205 (e.g., for processing TSD data 131 to determine obstruction intensity data 133 and/or diversion confidence data 135), and an output module 207 (e.g., for outputting diversion confidence data 135). The above presented modules and components of the mapping platform 107 can be implemented in hardware, firmware, software, or a combination thereof. Though depicted as a separate entity in FIG. 1, it is contemplated that the mapping platform 107 may be implemented as a module of any of the components of the system 100 (e.g., a component of the services platform 123, services 125, content providers 127, vehicles 115, UEs 117, applications 119, and/or the like). In another embodiment, one or more of the modules 201-207 may be implemented as a cloud-based service, local service, native application, or combination thereof. The functions of the mapping platform 107 and modules 201-207 are discussed with respect to the figures below.

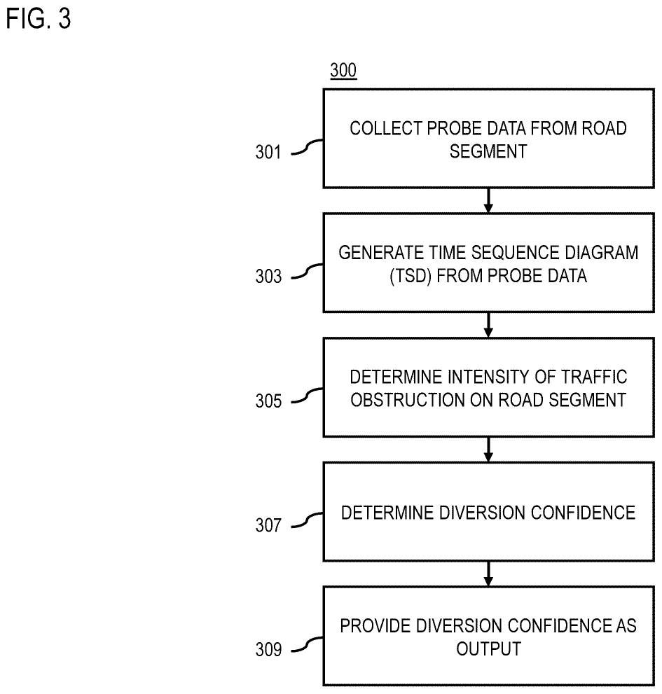

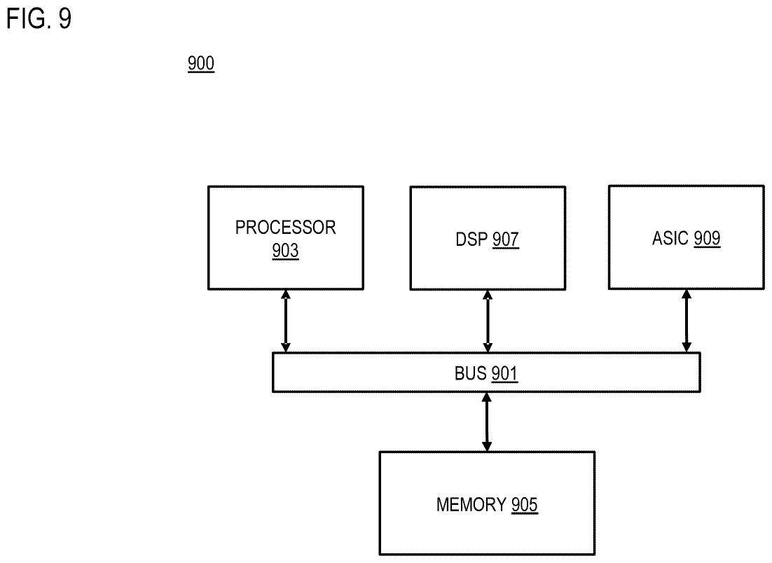

FIG. 3 is a flowchart of a process 300 for detecting road obstruction intensity for routing or mapping, according to one embodiment. In various embodiments, the mapping platform 107 and/or any of the modules 201-207 may perform one or more portions of the process 300 and may be implemented in, for instance, a chip set including a processor and a memory as shown in FIG. 9. As such, the mapping platform 107 and/or any of the modules 201-207 can provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 may be performed in any order or combination and need not include all of the illustrated steps.

It is contemplated that the process 300 can be performed on a server (e.g., via the mapping platform 107) and/or on a client device (e.g., vehicle 115, UE 117 or equivalent) using the application 119. In addition, process 300 can be performed as a batch process or in real-time as road obstruction detection data 111, sensor data 121, and/or probe data 129 (or other equivalent data) are collected or otherwise received.

In step 301, the mapping platform 107 initiates a collection of probe data 129 associated with a road segment 103. In one embodiment, the collection of the probe data 129 is initiated when a road obstruction 101 is detected on the road segment 103 of interest. As previously discussed, the detection of the road obstruction 101 (e.g., obstruction detection data 111) can be provided by a transportation management agency 109 (or other equivalent data source external to the mapping platform 107 such as but not limited to the services platform 123, services 125, and/or content providers 127).

In another embodiment, the mapping platform 107 can use sensor data 121 (e.g., image data, LIDAR, radar, etc.) collected from vehicles 115/UEs 117 traveling on the road segment 103 of interest to detect the presence of a road obstruction 101. For example, the sensor module 201 of the mapping platform 107 retrieves sensor data 121 (e.g., image data) captured using a sensor of a vehicle 115 or UE 117. In one embodiment, the vehicle 115/UE 117 is determined to be traveling on the road segment 103 (e.g., by map matching location data sensed by the vehicle 115/UE 117 to the road segment 103). Accordingly, the sensor data 121 (e.g., image data) is likely to depict any road obstruction 10 that may be affecting the road segment 103 (e.g., an image depicting an accident, object in the road, construction, etc.). The sensor used to capture the sensor data 121 includes but is not limited to a camera, radar sensor, LIDAR sensor, and/or equivalent. A camera, for instance, can produce a visible image. The radar sensor can produce an image based on radar backscatter of radar frequencies (e.g., typically 300 MHz to 30 GHz), and the LIDAR sensor can produce an image based on reflected laser light. It is contemplated that the images can be two-dimensional or three-dimensional images. In one embodiment, the sensor data 121 is a sequence of images respectively associated with a capture time, a capture geolocation, or a combination thereof. In other words, each sensor data instance (e.g., each image) has metadata indicating where and when each sensor data 121 instance was captured. In one embodiment, a computer vision system or other trained machine learning system 137 can process the sensor data to detect a road obstruction 101. It is noted that the examples of road obstruction detection systems described herein are provided by way of illustration and not as illustration. It is contemplated that any type of road obstruction detection or reporting system can be used according to the embodiments described herein.

After detecting or otherwise receiving road obstruction detection data 111 indicating a road obstruction 101 on a road segment 103 of interest, the mapping platform 107 (e.g., via the probe data module 203) can begin collecting or request the collection of probe data 129 from probe devices (e.g., vehicles 115/UEs 117) that are traveling on the road segment 103 interest. It is contemplated that the probe data 129 can be collected for any duration or time period (e.g., the most recent 30-minute time epoch or any other designated time duration).

For example, the mapping platform 107 retrieves real-time probe data 129 (e.g., trajectory or path data) driving on the road segment 103 of interest. The road segment 103 can be represented by one or more road links of the geographic database 105. The probe data 129, for instance, is a collection of probes comprising a probe identifier (e.g., to uniquely identify probes from a single vehicle 115 or UE 117), geolocation (e.g., latitude and longitude determined by a location sensor such as, but not limited to, a satellite-based location receiver, or equivalent), a timestamp, and optionally additional parameters such as, but not limited to, a speed, a heading, and/or the like.

The sensor module 201 then map matches the probe data 129 on either a road or lane level depending on whether the road obstruction intensity data 133 and/or diversion confidence data 135 are to be tracked on a road or lane level. Map matching, for instances, comprises translating raw geolocation coordinates (e.g., latitude, longitude) to a position on a road link segment stored in the geographic database 105. It is contemplated that the mapping platform 107 can use any map matching method known in the art.

In one embodiment, the mapping platform 107 need not trigger probe data collection based on detection of detecting a road obstruction 101. Instead, the probe data 129 can be collected continuously are part of monitoring of the road segment regardless of whether a road obstruction 101 has been detected on the monitored road 103.

In step 303, the processing module 205 processes the probe data 129 (e.g., collected according to step 301) to generate a TSD. The TSD, for instance, plots the probe data 129 according to distance from an origin point on the road segment 103 over time. By way of example, a TSD is used to solve a number of transportation-related problems. Typically, time is drawn on the horizontal axis and distance from a reference point on the vertical axis. The trajectories of individual vehicles in motion are portrayed in this diagram by sloping lines, and stationary vehicles are represented by horizontal lines. The slope of the line represents the speed of the vehicle. Curved portions of the trajectories represent vehicles undergoing speed changes such as acceleration or deceleration.

For example, the TSD is plotted from the probe data 129 based on the following input including but not limited to:
Locations (Lat, Lon) of probe points of each trajectory in the probe data 129;
Time range (few minutes to hours) to plot in the TSD; and
Map matched links of the road segment 103 of interest arranged in sequence of direction of travel.

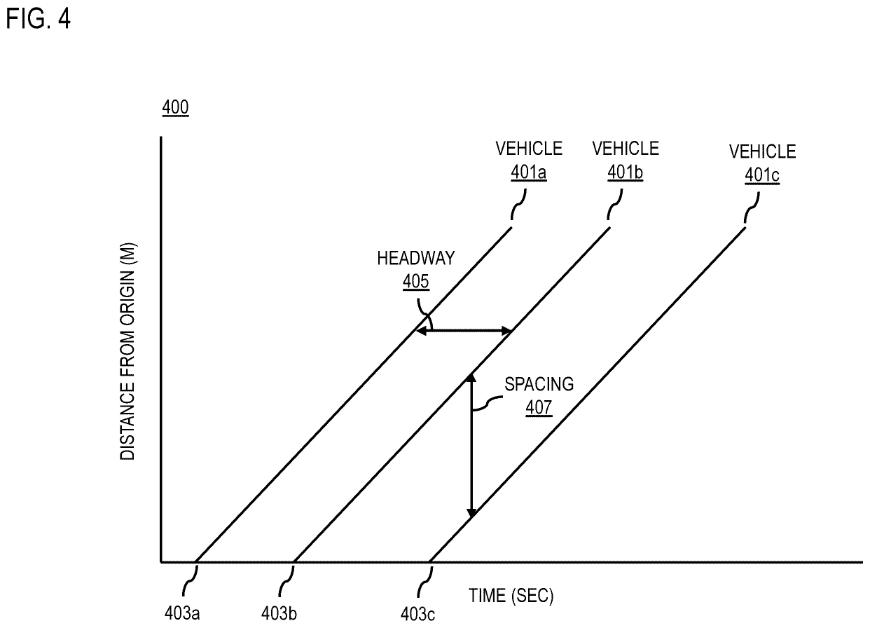

FIG. 4 is a diagram illustrating an example TSD 400, according to one embodiment. As shown, the vertical axis of the TSD represents distance from an origin point on the road segment of interest 103. The origin point can be any location on the road segment 103. Typically, the road segment comprises one or more road links of the geographic database 105 where the road links represent the road segment using a link-node representation. One example origin point can be the beginning node of the first road link in the sequence of links arranged in the direction of travel. However, it is contemplated that any point along the road segment 103 and/or its constituent road links can be used. The horizontal axis represents time over designated time range. The designated time range is used to select the probe data 129 collected from vehicles with timestamps falling within the time range.

A probe point can be placed on the road link through map matching to determine the distance from the origin point on the road segment 103 of interest, and the timestamp at which the probe point is collected. In this example, the plotted probe data 129 includes trajectories from three different vehicles 401a-401c. The probe data 129 is sequenced by time for each of the vehicles 401a-401c into respective vehicle trajectories 403a-403c, and the trajectories 403a-403c are plotted on the TSD 400. As noted above, the speed of the vehicles 401a-401c are represented as the slopes of their respective trajectories 403a-403c. In this case, the trajectories 403a-403c have the same slopes indicating that the vehicles 401a-401c are traveling on the road segment 103 at the same speeds. The vehicles are separated in time (e.g., represented by the horizontal distance between trajectories and referred to as headway 405) and distance (e.g., represented by the vertical distance between trajectories and referred to as spacing 407). As shown, the headway 405 between the vehicles is approximately between 1.0 and 2.0 seconds, and the spacing 407 is approximately between 2.0 and 3.0 meters.

In step 305, the mapping platform 107 determines an intensity of the road obstruction based on the TSD. In one embodiment, the intensity of the road obstruction 101 is based on its impact on the traffic (e.g., traffic speed) on the road segment 103. As discussed above, the speed of a vehicle plotted on a TSD is indicated by the slope of its trajectory. By plotting the probe data 129 of a plurality of vehicles 115 on a TSD corresponding to a road segment 103 of interest, the TSD can provide a visualization from which overall traffic impacts of a road obstruction 101 (e.g., intensity of the road obstruction 101) can be determined.

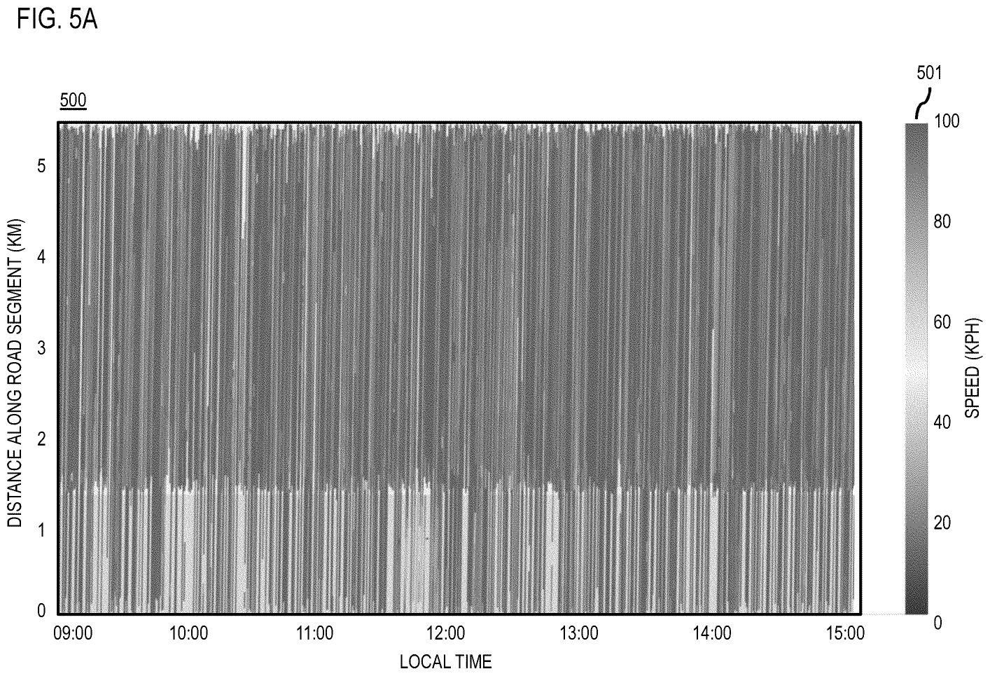

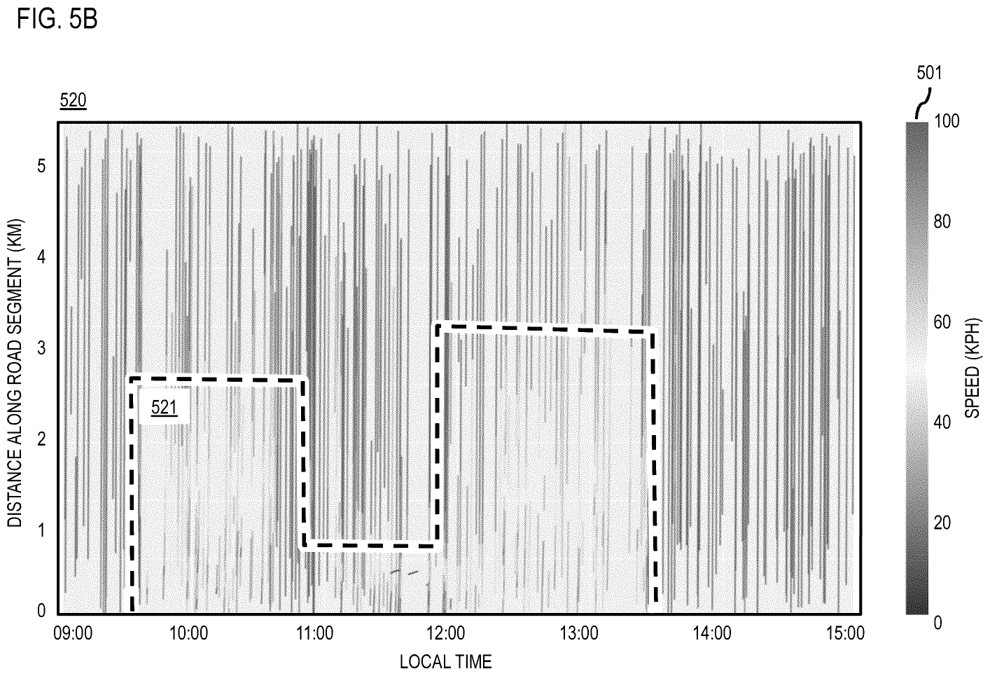

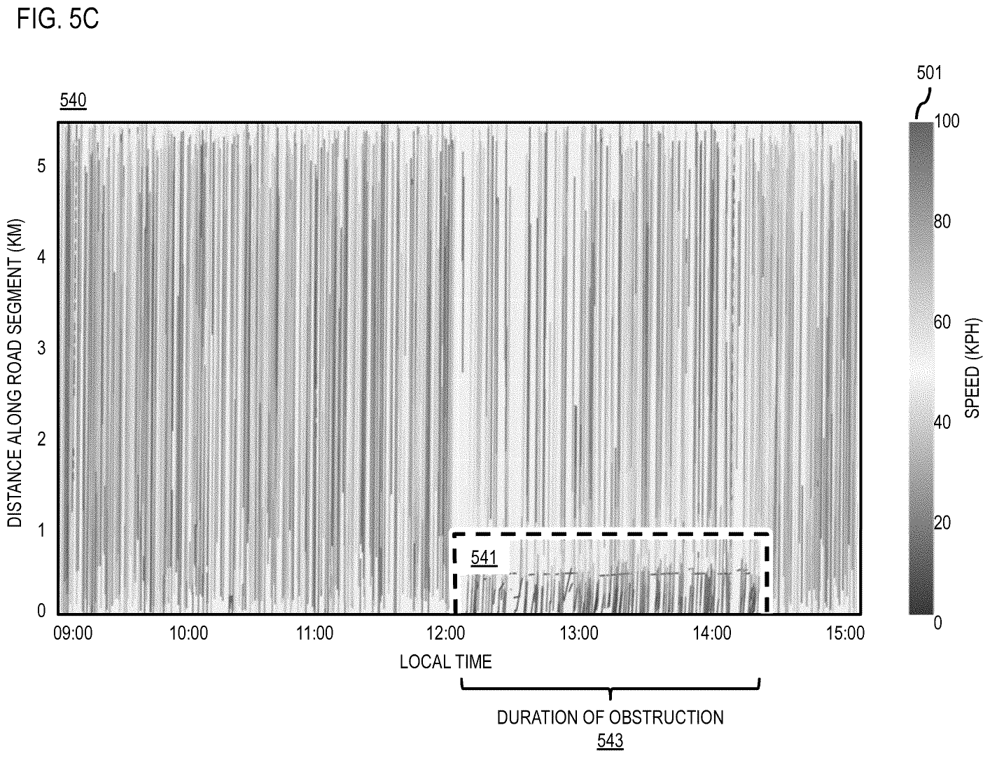

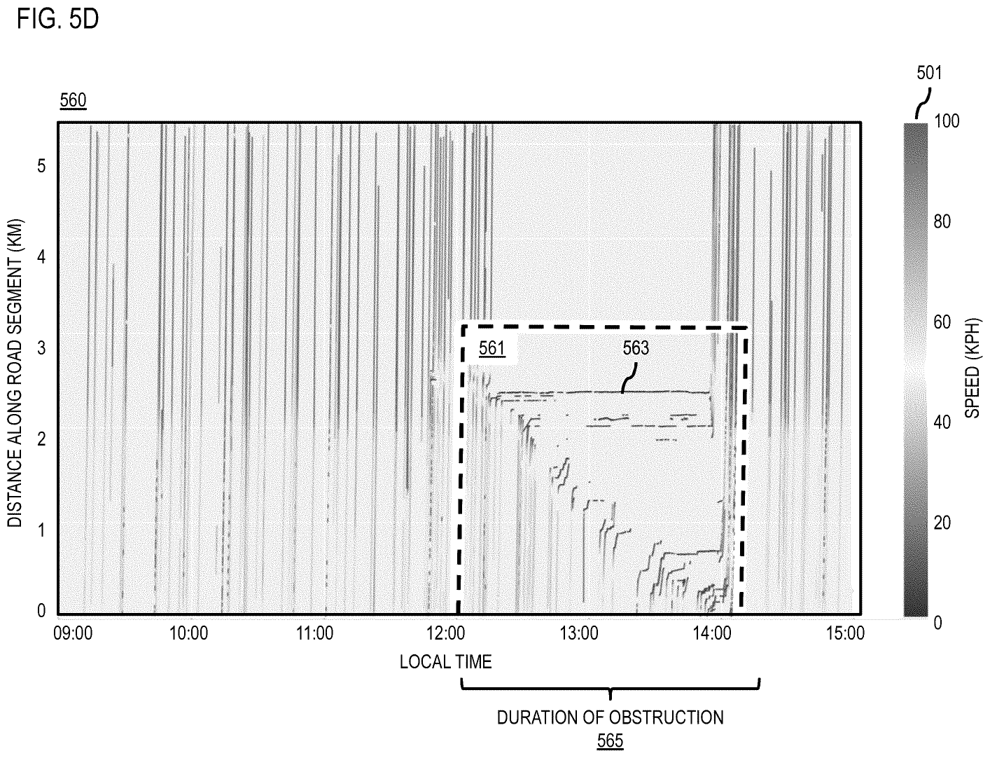

Generally, mapping service providers (e.g., operators of the mapping platform 107) continuously collect a wealth of probe data 129 from a large number vehicles from road networks across the world. This extensive probe data collection makes it easy to plot a TSD for most road segments 103 and have a data rich plot (e.g., a TSD plot with a dense or minimum number of vehicle trajectories). FIGS. 5A-5D are diagrams illustrating example TSDs representing road obstructions of varying intensities, according to various embodiments.

FIG. 5A illustrates a TSD 500 with no or minimal traffic speed reduction, according to one embodiment. As shown in FIG. 5A, the right-hand side legend 501 shows the variation in speed allowed on that road correlated to different shades. In this particular case, the maximum speed allowed on the corresponding road segment 103 is 100 kilometers per hour (kph), which is shown as a corresponding shade. On the other hand, the minimum speed on the road segment 103 is 0 kph shown by another corresponding shade. Speeds between the minimum and maximum ranges also have corresponding shades. In the TSD 500, probe trajectories for vehicles traveling on the road segment 103 are plotted and appear almost vertical because the time duration of the TSD 500 is a 6-hour time range (e.g., spanning from 09:00 to 15:00). This plot is dense with trajectories covering the entire time range. In this example, most of the probe or trajectory lines correspond to shades at or close to the maximum speed (e.g., 100 kph), which indicates that there are no obstructions to traffic and traffic is free moving (e.g., no intensity road obstruction).

FIG. 5B illustrates a TSD 520 with a slight traffic speed reduction, according to one embodiment. The TSD 520 of FIG. 5B has the same scale and legend 501 as FIG. 5A. In this example, the region 521 marks an area of the TSD 520 where there is combination of shaded probe trajectory lines corresponding to a nearly 50% speed reduction and a few shaded probe trajectory lines corresponding to a standstill or minimum speed. Nevertheless, the traffic is still flowing with reduced speed and with congestion indicating that there may be a road obstruction 101 with minor or slight intensity (e.g., low intensity road obstruction).

FIG. 5C illustrates a TSD 540 with a moderate traffic speed reduction, according to one embodiment. The TSD 540 of FIG. 5D has the same scale and legend 501 as FIG. 5A. In this example, there is a standstill traffic to some extent as shown in the shading in lower half of the region 541. The standstill state is also shown by horizontal or nearly horizontal slopes of the some of the probe trajectories lines in the region 541. However, there are probe trajectory lines above the region 541 which indicates that some vehicles are still moving past the road obstruction point on the y-axis but with very heavy congestion. The width of the region 541 along the x-axis shows the time duration of the congestion 543. In this case the congestion lasted for approximately 2 hours (e.g., from 12:15 to 14:15). Thus, the TSD 540 indicates the intensity of the road obstruction 101 is at a medium intensity.

FIG. 5D illustrates a TSD 560 with a heavy traffic speed reduction, according to one embodiment. The TSD 560 of FIG. 5D has the same scale and legend 501 as FIG. 5A. As shown in region 561, there no probe trajectory lines beyond a horizontal trajectory line 563 indicating that there are no probe vehicles beyond the horizontal trajectory line 563. The slope of the horizontal trajectory line 563 is also zero or near zero indicating that the corresponding probe vehicles are at a standstill. In addition, no probe trajectory lines beyond the horizontal trajectory line 563 indicates that all of the traffic on the road segment 103 has come to a halt and the movement of vehicles is completely obstructed. In this particular case, vehicles cannot pass this road from 11:15 am to 13:00 pm (e.g., duration of obstruction 565). Thus, the TSD 560 indicates the intensity of the road obstruction 101 is at a high intensity.

It is noted that the example of intensity classifications described above (e.g., no intensity, low intensity, medium intensity, and high intensity) are provided by way of illustration and not as limitations. The number and labels of the intensity classes can vary and be designated according to any equivalent rule or heuristic. For example, the intensity classifications can be labeled as class 1, class 2, class 3, and class 4 as described below. In one embodiment, the number and types of classes can be determined using clustering (e.g., k-means clustering or equivalent) of ground truth TSD obstruction intensity classifications. In yet another embodiment, the mapping platform 107 can use unsupervised machine learning or equivalent algorithms to automatically determine and classify obstruction intensity classifications.

In step 307, the mapping platform 107 determines a diversion confidence for diverting a route from the road segment based on the intensity of road obstructions determined, for instance, using the TSD as described in the embodiments of step 305. In one embodiment, the various embodiments described herein leverages sensor data 121 (e.g., to detect the presence of road obstructions 101) in combination from probe data TSD to determine whether to change the navigation route of a vehicle 115 (e.g., an autonomous vehicle), based on the intensity of the detected road obstruction 101.

By way of example, FIGS. 5A-5D illustrate examples of different intensities of the road obstructions 101 (e.g., intensities based on effect of the road obstructions on traffic on a corresponding road segment 103) which may be caused accidents, broken down vehicles, road construction etc. In one embodiment, if a vehicle 115 (e.g., an autonomous vehicle) has this information (e.g., obstruction detection data 111 and/or obstruction intensity data 133), then the vehicle 115 can decide whether to take this route (e.g., comprising a road segment 103 affected by the road obstruction 101) or take an alternative route (e.g., divert around or not travel on the affected road segment 103). In one embodiment, to facilitate the decision process for the vehicle 115, the intensity of the road obstruction can be divided into designated categories such as, but not limited to, the four obstruction intensity categories as shown in FIGS. 5A-5D.

Table 1 below illustrates example obstruction intensity classes and corresponding weights for determining a diversion confidence for the affected road segment 103.

TABLE 1

| Obstruction | | |
|---|---|---|
| Intensity | Description | Weight |
| Class 1 | Traffic is free flowing with no obstructions. | 0.2 |
| Class 2 | There is obstruction but traffic is flowing with | 0.4 |
| | reduced speed (greater than 50% of legal speed). | |
| Class 3 | There is obstruction but traffic is flowing with | 0.6 |
| | significantly reduced (less than 50% of legal | |
| | speed). | |
| Class 4 | The vehicle movement is stopped. No probe line | 0.8 |
| | is detected in at least one downstream portion of | |
| | the TSD. | |

As shown in Table 1, in one example embodiment, the mapping platform 107 can designate four obstruction intensity categories (e.g., Classes 1-4) with a description of each category describing characteristics or criteria of the TSD for applying the corresponding obstruction intensity class. The weight of each obstruction intensity class is also provided for computing the diversion confidence in the embodiments described further below.

In one embodiment, instead of using heuristics or criteria for classifying the obstruction intensity of a probe data TSD, the mapping platform 107 can use a trained machine learning classifier (e.g., the trained machine learning system 137). In one non-exclusive example, to use machine learning, the mapping platform first converts the TSD to an image. For example, the image can depict the TSD as illustrated in FIGS. 5A-5D to indicate probe trajectory speed, slope, presence/absence of probe trajectory lines, duration of obstructions, etc. The mapping platform 107 then processes the using a trained machine learning model to determine the intensity, the diversion confidence, or a combination thereof.

More specifically, in one embodiment, the image representation of the TSD is processed using machine learning (e.g., via a machine learning system 137 including a trained machine learning model or algorithm) to identify obstruction intensity of the corresponding road obstruction 101. The TSD is converted to an image-like input format because one technique that has shown significant ability to detect features in images is the use of convolutional neural networks (CNN). Neural networks have shown unprecedented ability to recognize features (e.g., features indicative of road obstruction intensity in TSDs such as but not limited to shading of probe trajectory lines to indicate speeds, slopes of the lines, presence/absence of the lines. width of TSD feature corresponding to obstructions, etc. in images. Trained CNNs (or equivalent) can also understand the semantic meaning of images, and segment images according to these semantic categories that, for instance, correspond to road obstruction intensifies and/or diversion confidences. An example of a CNN-based feature detector includes, but is not limited to, the You Only Look Once (YOLO) Real Time Object Detection Algorithm or equivalent.

The input or training images, for instance, include multiple images of TSDs created at different times, road segments, environments, etc. to identify road obstruction intensities and/or diversion confidences. The CNN algorithm is able to train itself on a large database of ground truth TSD images under different contexts (e.g., different types of roads, weather conditions, lighting conditions, time of day, etc.) and/or different known obstruction intensities. In one embodiment, the output of the machine learning system 137 can include, but is not limited to, a predicted obstruction intensity (e.g., a designated class of obstruction intensity) and/or a predicted diversion confidence.

As discussed previously, the road obstruction 101 can be detected by sensor data 121. Sensor data 121 can detect obstructions like accidents, broken down vehicles, road works, fire hazards, constructions, and/or any other type of obstruction that can affect traffic on a road segment 103. Therefore, in one embodiment, sensor data 121 is used as a starting point to identify the obstruction 101 in the path (e.g., but not the intensity of the road obstruction 101). Once the obstruction 101 is identified by the sensor data 121, TSDs are plotted for that particular section using probe data 129 according to the various embodiments described herein. Based on the obstruction intensity class of the TSD, a diversion confidence score is calculated for route diversion (or any other applications using a diversion confidence) as described below.

In one embodiment, the mapping platform can determine the diversion confidence (also referred to as “confidence for route diversion” by computing the weights of sensor based obstruction detection and/or weights corresponding to the road obstruction intensity determined from a TSD. For example, the computation is described by the following equation:

Confidence for route diversion=Weight of sensor data detection+weight of TDS class

The weight of sensor data detection refers to a weight assigned to the detection of a road obstruction 101 or a road segment 103 (also referred to as “detection weight). In one embodiment, the detection weight can be a fixed value (e.g., a value of “0.2” or any other designated value). In other embodiments, the mapping platform 107 determines a detection weight of the road obstruction based on the sensor data used for the detecting of the road obstruction so that the detection weight can be variable. For example, the weight can be based on factors such as, but not limited to, the type or quality of the sensor data or confidence of detection of the road obstruction. The diversion confidence can then be further based on the detection weight.

In one embodiment, the mapping platform 107 determines an intensity weight based on the intensity of the road obstruction 101. By way of example, the intensity can be classified according to one or more classes, and then the one or more classes are associated with a respective intensity weight for determining the diversion confidence. The diversion confidence is then further based on the intensity weight.

In other words, in one embodiment, the weight of sensor (e.g., detection weight) is fixed at specified value (e.g., 0.2)because it is used only to detect the obstruction but not to estimate the intensity of obstruction. Whereas the TSD is used to determine the intensity of the obstruction 101, so it has variable weight (e.g., variable according to obstruction intensity).

In one embodiment, the weight of the TDS obstruction intensity class is in the steps of 0.2, starting from 0.2 and ranging till 0.8 as shown in Table 1 above. It is noted that this weighting is provided by way of illustration and not as a limitation. It is contemplated that any equivalent weighting scheme (e.g., range, steps, etc.) can be used according to the embodiments described herein.

In one example, if the sensor data 121 detects a road obstruction 101 (e.g., detection weight=0.2, according to the example fixed value) and TSD obstruction intensity falls in class 3 (e.g., intensity weight=0.6, according to the example of Table 1), then the diversion confidence is calculated as follows:

Diversion Confidence=0.2+0.6=0.8

In another example, if a road obstruction 101 is not detected by sensor data 121 (e.g., detection weight=0.0) but by TSD at obstruction intensity class 3 (e.g., intensity weight=0.6), then the diversion confidence is calculated as follows:

Diversion Confidence=0+0.6=0.6

In another example, if sensor data 121 detects a road obstruction 101 (e.g., detection confidence=0.2) but a corresponding TSD does not (e.g., intensity weight=0), then the diversion confidence is calculated as follows:

Diversion Confidence=0.2+0=0.2

Thus, the diversion confidence can be determined based on the detection of a road obstruction 101 using sensor data 121 (or reported road obstruction detection event from the transportation management agency or equivalent) (e.g., road obstruction detection data 111) and/or the road obstruction intensity data 133.

In step 309, the mapping platform 107 provides the determined diversion confidence as an output (e.g., diversion confidence data 135). It is contemplated that the diversion confidence output of the mapping platform 107 can be used for any application or service (e.g., applications and/or services of the mapping platform 107, services platform 123, services 125, content providers 127, etc.).

For example, in one embodiment, the mapping platform 107 configures a vehicle 115 (e.g., autonomous vehicle) to divert around the road segment based on the diversion confidence. In this way, the autonomous vehicle 115 can avoid a potentially unsafe or less safe scenario created by potential road obstructions 101 in its way that its autonomous system would have to try to safely avoid or require manual driving intervention.

In one embodiment, the mapping platform 107 configures a vehicle 115 to divert around the road segment based on determining that the diversion confidence is greater than a threshold confidence (e.g., 0.5 on a 0.0 to 1.0 scale). The mapping platform 107 can also transmit or initiating the transmission of an alert message indicating the road obstruction to one or more vehicles within a predetermined proximity of the road segment based. In one embodiment, the alert message is transmitted also based on determining that the diversion confidence is above a threshold confidence (e.g., this threshold confidence can be the same or different as the threshold used for diverting around the affected road segment 103).

In other words, a configurable diversion confidence threshold is fixed or otherwise specified (for example 0.5). If an autonomous vehicle 115 computes a diversion confidence of a road obstruction 101 that is greater than 0.5, then it will send a signal to all the vehicle within a radius of 2 Km (configurable) about the forthcoming obstruction, while also taking an alternative route. If the confidence is greater than 0.5 then the oncoming vehicle will look for alternative route.

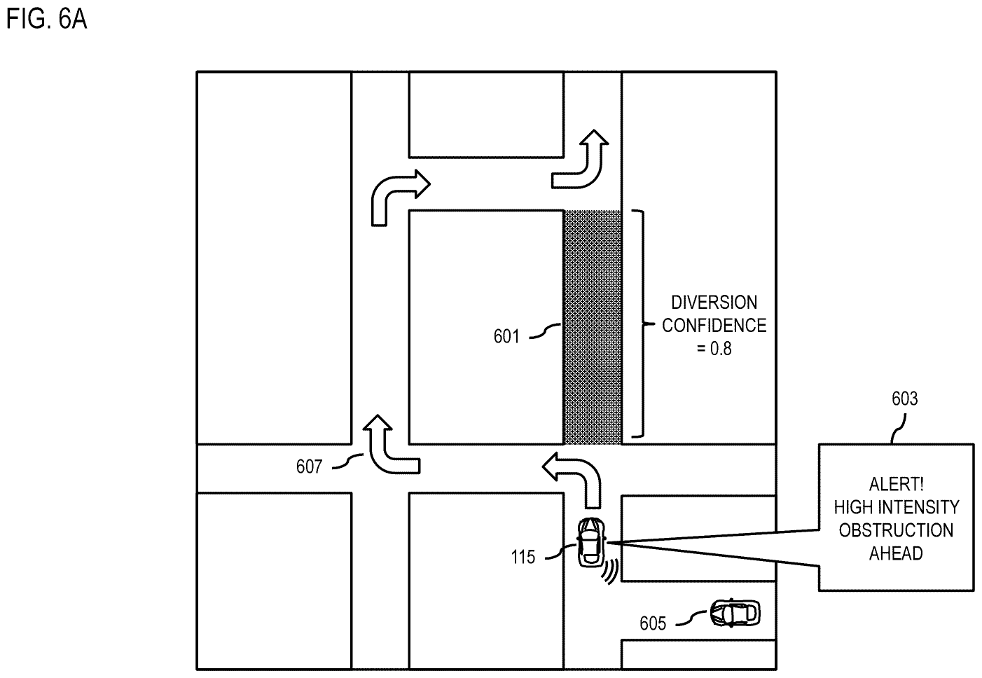

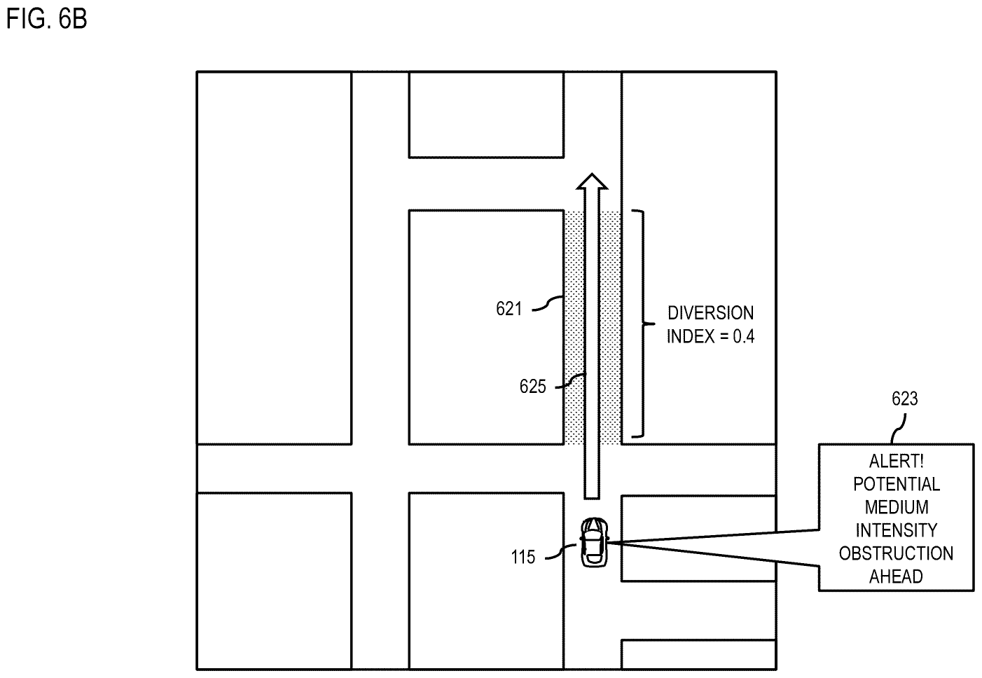

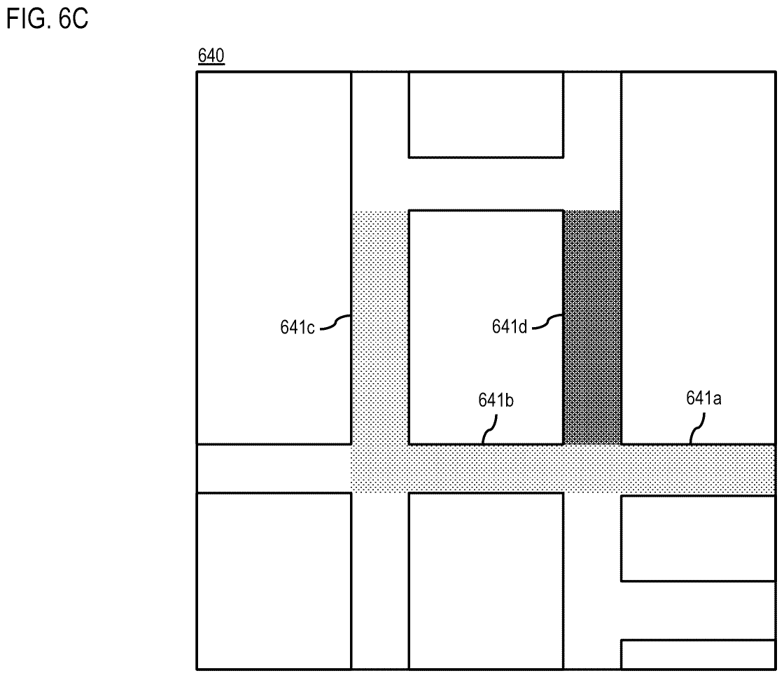

FIG. 6A illustrates an example of using road obstruction intensity data under the above scenario, according to one embodiment. In the example of FIG. 6A, an autonomous vehicle 115, is approaching a road segment 601 with a computed diversion confidence equal to 0.8 based on a TSD approach of the various embodiments described herein. The road segment 601 is shaded dark gray to indicate the high diversion confidence. In response, the autonomous vehicle 115 transmits an alert message 603 to another vehicle 605 within a threshold radius. The autonomous vehicle 115 will also divert from taking the road segment 601 by taking an alternative route 607 that bypasses the road segment 601. In addition, the alert message 603 can include the computed diversion confidence for the road segment 601. On receiving the alert message 603, the other vehicle 605 can also take an alternative route that bypasses road segment 601 because the compute diversion confidence is above the specified threshold value.

In one embodiment, if the computed diversion confidence is less than 0.5, then the autonomous vehicle 115 will not take alternative route but will warn any passengers of the vehicle 115 about the oncoming road obstruction 101. In this way, the passenger can be on alert to take manual control if the autonomous vehicle 115 is unable to autonomously negotiate the road obstruction 101. In other words, as illustrated in the example of FIG. 6B, if the computed diversion confidence for road segment 621 (e.g., computed at 0.4) is below the 0.5 designated threshold, the mapping platform 107 initiates a presentation of an alert message 623 indicating the road obstruction on the road segment 621 to a passenger of the vehicle 115. The alert message 623, for instance, can be presented when the vehicle 115 approaches or is otherwise traveling within a predetermined proximity of the road segment 621. In this case, the alert message 623 is presented without diverting the vehicle 115 around the road segment 621, e.g., to continue on a route 625 through the road segment 621.

In one embodiment, the mapping platform 107 use the computed diversion confidence for various road segments 103 or road links to present a mapping user interface. For example, computed diversion confidence data 135 and/or obstruction intensity data 133 can be stored as a map layer of the geographic database 105 for various road links. The map data layer can then be used to present a mapping user interface comprising representations of the diversion confidence data 135 and/or obstruction intensity data 133. It is contemplated that any type of representation can be used including but not limited to colors, highlighting, line weights, etc.

FIG. 6C is a diagram illustrating an example mapping user interface 640 based on diversion confidence data, according to one embodiment. In this example, the mapping user interface 640 depicts a portion of a road network comprising multiple road segments. Diversion confidence values have been computed based on probe data TSDs for road segments 641a-641d according the various embodiments described herein. As shown, road segments 641a-641c are classified as class 2 obstruction intensity (e.g., represented using light shading of road segments 641a-641c) while road segment 641d is classified as a class 4 obstruction intensity (e.g., represented using darker shading of road segment 641d).

Returning to FIG. 1, as shown, the system 100 includes the mapping platform 107 for detecting road obstruction intensity based on sensor data 121 and/or probe data 129. In one embodiment, the mapping platform 107 has connectivity over the communication network 113 to services platform 123 that provides one or more services 125 that can use the road obstruction intensity data 133 and/or diversion confidence data 135 for downstream functions. By way of example, the services 125 may be third party services and include but is not limited to autonomous driving applications, mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services 125 uses the output of the mapping platform 107 (e.g., road obstruction detection data 111, road obstruction intensity data 133 and/or diversion confidence data 135) to provide services such as navigation, mapping, other location-based services, etc. to the vehicles 115, UEs 117, applications 119, and/or other client devices.

In one embodiment, the mapping platform 107 may be a platform with multiple interconnected components. The mapping platform 107 may include multiple servers, intelligent networking devices, computing devices, components, and corresponding software for determining map feature identification confidence levels for a given user according to the various embodiments described herein. In addition, it is noted that the mapping platform 107 may be a separate entity of the system 100, a part of one or more services 125, a part of the services platform 123, or included within components of the vehicles 115 and/or UEs 117.

In one embodiment, content providers 127 may provide content or data (e.g., including sensor data 121 (e.g., image data), probe data 129, related geographic data, etc.) to the geographic database 105, machine learning system 137, the mapping platform 107, the services platform 123, the services 125, the vehicles 115, the UEs 117, and/or the applications 119 executing on the UEs 117. The content provided may be any type of content, such as imagery, sensor data, probe data, machine learning models, map embeddings, map content, textual content, audio content, video content, image content, etc. In one embodiment, the content providers 127 may provide content that may aid in detecting road obstruction intensity according to the various embodiments described herein. In one embodiment, the content providers 127 may also store content associated with the geographic database 105, mapping platform 107, services platform 123, services 125, and/or any other component of the system 100. In another embodiment, the content providers 127 may manage access to a central repository of data, and offer a consistent, standard interface to data, such as a repository of the geographic database 105.

In one embodiment, the vehicles 115 and/or UEs 117 may execute software applications 119 to use road obstruction detection data 111, road obstruction intensity data 133, diversion confidence data 135, or other data derived therefrom according to the embodiments described herein. By way of example, the applications 119 may also be any type of application that is executable on the vehicles 115 and/or UEs 117, such as autonomous driving applications, routing applications, mapping applications, location-based service applications, navigation applications, device control applications, content provisioning services, camera/imaging application, media player applications, social networking applications, calendar applications, and the like. In one embodiment, the applications 119 may act as a client for the mapping platform 107 and perform one or more functions associated with determining map feature identification confidence levels alone or in combination with the mapping platform 107.

By way of example, the vehicles 115 and/or UEs 117 are or can include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the vehicles 115 and/or UEs 117 can support any type of interface to the user (such as “wearable” circuitry, etc.). In one embodiment, the vehicles 115 and/or UEs 117 may be associated with or be a component of a vehicle or any other device.

In one embodiment, the vehicles 115 and/or UEs 117 are configured with various sensors for generating or collecting sensor data 121, probe data 129, related geographic data, etc. In one embodiment, the sensed data represent sensor data associated with a geographic location or coordinates at which the sensor data was collected, and the polyline or polygonal representations of detected objects of interest derived therefrom to generate the digital map data of the geographic database 105. By way of example, the sensors may include a global positioning sensor for gathering location data (e.g., GPS), IMUs, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors of the vehicles 115 and/or UEs 117 may include light sensors, orientation sensors augmented with height sensors and acceleration sensor, tilt sensors to detect the degree of incline or decline (e.g., slope) along a path of travel, moisture sensors, pressure sensors, etc. In a further example embodiment, sensors about the perimeter of the vehicles 115 and/or UEs 117 may detect the relative distance of the device or vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the vehicles 115 and/or UEs 117 may include GPS or other satellite-based receivers to obtain geographic coordinates from positioning satellites for determining current location and time. Further, the location can be determined by visual odometry, triangulation systems such as A-GPS, Cell of Origin, or other location extrapolation technologies.

In one embodiment, the communication network 113 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 107, services platform 123, services 125, vehicles 115 and/or UEs 117, and/or content providers 127 communicate with each other and other components of the system 100 using well known, new or still developing protocols. In this context, a protocol includes a set of rules defining how the network nodes within the communication network 113 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

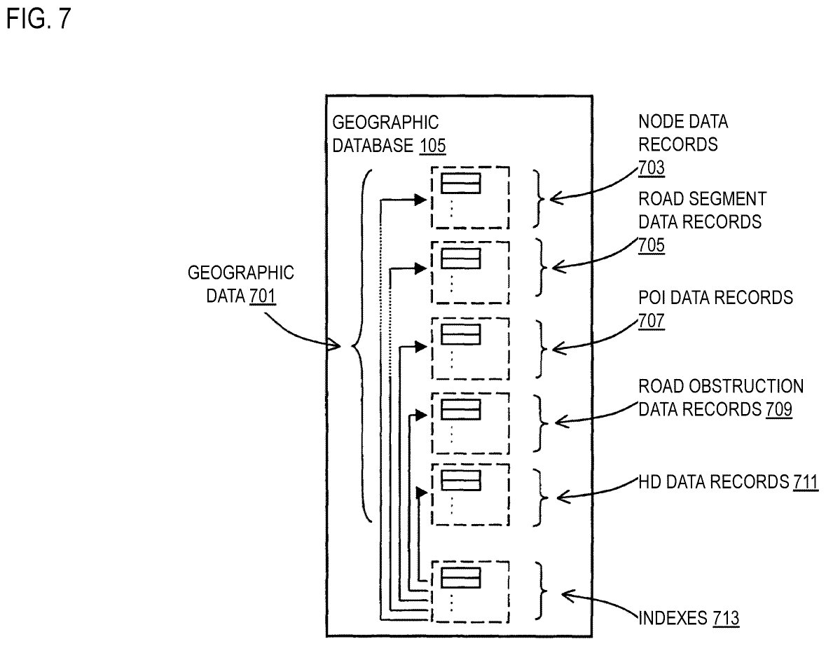

FIG. 7 is a diagram of a geographic database 105, according to one embodiment. In one embodiment, the geographic database 105 includes geographic data 701 used for (or configured to be compiled to be used for) mapping and/or navigation-related services, such as for providing map embedding analytics according to the embodiments described herein. For example, the map data records stored herein can be used to determine the semantic relationships among the map features, attributes, categories, etc. represented in the geographic data 701. In one embodiment, the geographic database 105 include high definition (HD) mapping data that provide centimeter-level or better accuracy of map features. For example, the geographic database 105 can be based on Light Detection and Ranging (LiDAR) or equivalent technology to collect billions of 3D points and model road surfaces and other map features down to the number lanes and their widths. In one embodiment, the HD mapping data (e.g., HD data records 711) and/or other mapping data of the geographic database 105 capture and store details such as but not limited to road attributes and/or other features related to generating speed profile data. These details include but are not limited to road width, number of lanes, turn maneuver representations/guides, traffic lights, light timing/stats information, slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent a footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the geographic database 105.

“Node”—A point that terminates a link.

“Line segment”—A line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 105 follows certain conventions. For example, links do not cross themselves and do not cross each other except at a node. Also, there are no duplicated shape points, nodes, or links. Two links that connect each other have a common node. In the geographic database 105, overlapping geographic features are represented by overlapping polygons. When polygons overlap, the boundary of one polygon crosses the boundary of the other polygon. In the geographic database 105, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 105 includes node data records 703, road segment or link data records 705, POI data records 707, road obstruction data records 709, HD mapping data records 711, and indexes 713, for example. More, fewer, or different data records can be provided. In one embodiment, additional data records (not shown) can include cartographic (“cartel”) data records, routing data, and maneuver data. In one embodiment, the indexes 713 may improve the speed of data retrieval operations in the geographic database 105. In one embodiment, the indexes 713 may be used to quickly locate data without having to search every row in the geographic database 105 every time it is accessed. For example, in one embodiment, the indexes 713 can be a spatial index of the polygon points associated with stored feature polygons. In one or more embodiments, data of a data record may be attributes of another data record.

In exemplary embodiments, the road segment data records 705 are links or segments representing roads, streets, or paths, as can be used in the calculated route or recorded route information for determination of speed profile data. The node data records 703 are end points (for example, representing intersections or an end of a road) corresponding to the respective links or segments of the road segment data records 705. The road link data records 705 and the node data records 703 represent a road network, such as used by vehicles, cars, and/or other entities. Alternatively, the geographic database 105 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 105 can include data about the POIs and their respective locations in the POI data records 707. The geographic database 105 can also include data about road attributes (e.g., traffic lights, stop signs, yield signs, roundabouts, lane count, road width, lane width, etc.), places, such as cities, towns, or other communities, and other geographic features, such as bodies of water, mountain ranges, etc. Such place or feature data can be part of the POI data records 707 or can be associated with POIs or POI data records 707 (such as a data point used for displaying or representing a position of a city).

In one embodiment, the geographic database 105 can also include road obstruction data records 709 for storing sensor data 121, probe data 129, road obstruction detection data 111, road obstruction intensity data 133, diversion confidence data 135, and/or any other related data that is used or generated according to the embodiments described herein. By way of example, the road obstruction data records 709 can be associated with one or more of the node records 703, road segment records 705, and/or POI data records 707 to associate the road obstruction data records 709 with specific road links, places, POIs, geographic areas, and/or other map features. In this way, the road obstruction data records 709 can also be associated with the characteristics or metadata of the corresponding records 703, 705, and/or 707.

In one embodiment, as discussed above, the HD mapping data records 711 model road surfaces and other map features to centimeter-level or better accuracy. The HD mapping data records 711 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 711 are divided into spatial partitions of varying sizes to provide HD mapping data to end user devices with near real-time speed without overloading the available resources of the devices (e.g., computational, memory, bandwidth, etc. resources).

In one embodiment, the HD mapping data records 711 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 711.

In one embodiment, the HD mapping data records 711 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the geographic database 105 can be maintained by the content provider 127 in association with the mapping platform 107 (e.g., a map developer or service provider). The map developer can collect geographic data to generate and enhance the geographic database 105. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 105 can be a master geographic database stored in a format that facilitates updating, maintenance, and development. For example, the master geographic database or data in the master geographic database can be in an Oracle spatial format or other format (e.g., capable of accommodating multiple/different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by vehicles 115 and/or UEs 117. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for detecting road obstruction intensity for routing or mapping may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

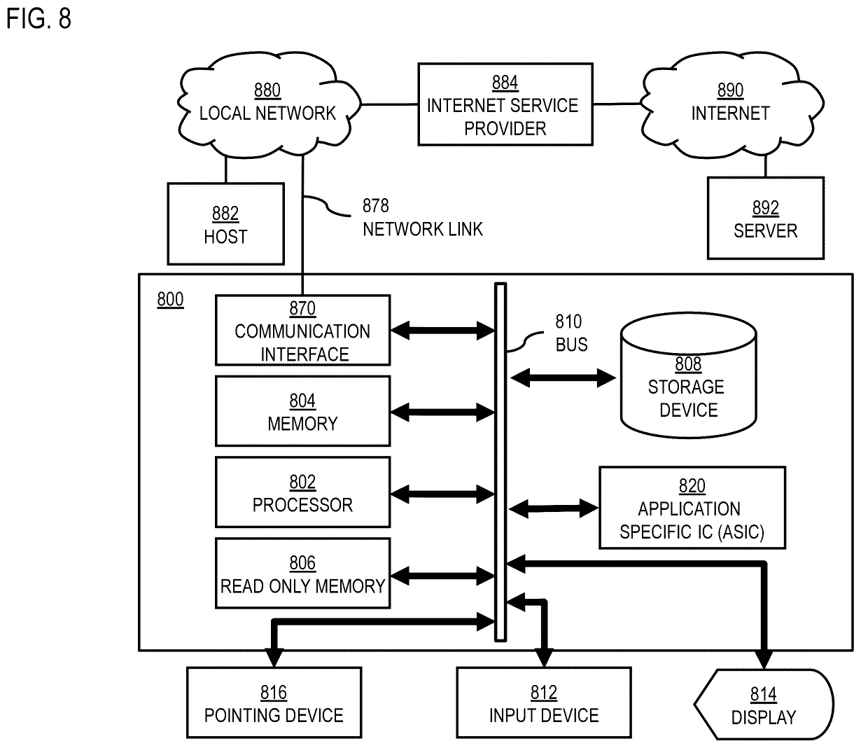

FIG. 8 illustrates a computer system 800 upon which an embodiment of the invention may be implemented. Computer system 800 is programmed (e.g., via computer program code or instructions) to detect road obstruction intensity for routing or mapping as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to detecting road obstruction intensity for routing or mapping. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RANI) or other dynamic storage device, stores information including processor instructions for detecting road obstruction intensity for routing or mapping. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for detecting road obstruction intensity for routing or mapping, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 113 for detecting road obstruction intensity for routing or mapping.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system can be deployed in various configurations within other computer systems, e.g., host 882 and server 892.

FIG. 9 illustrates a chip set 900 upon which an embodiment of the invention may be implemented. Chip set 900 is programmed to detect road obstruction intensity for routing or mapping as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to detect road obstruction intensity for routing or mapping. The memory 905 also stores the data associated with or generated by the execution of the inventive steps.

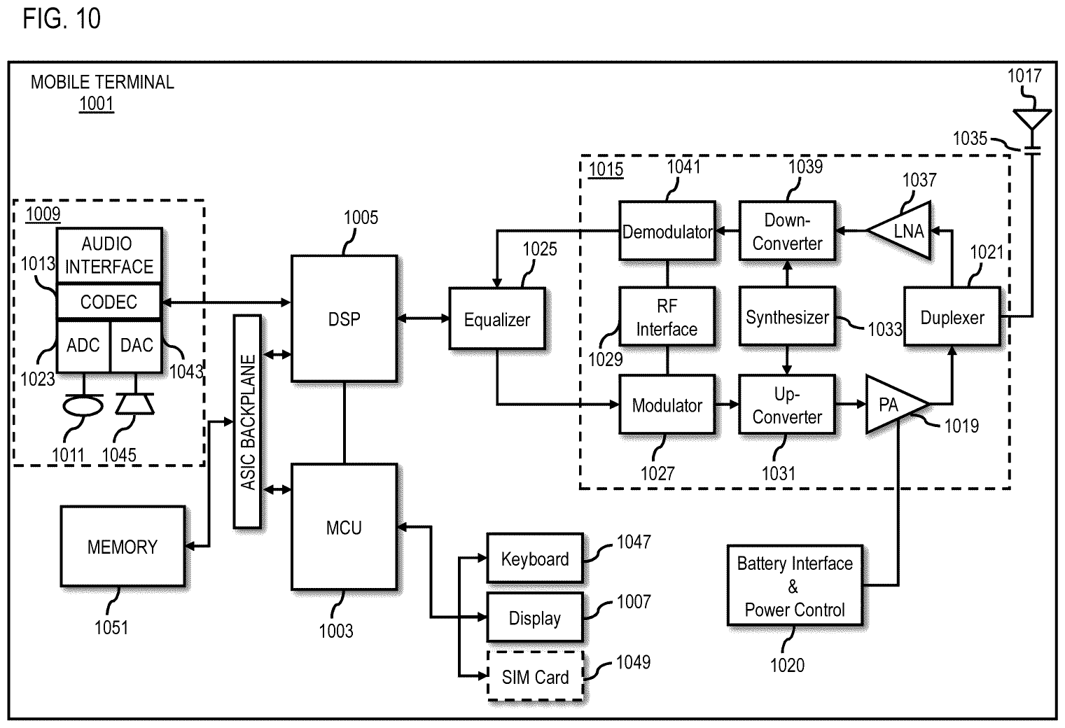

FIG. 10 is a diagram of exemplary components of a mobile terminal 1001 (e.g., the UE 117, vehicle 115, or component thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of the mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to detect road obstruction intensity for routing or mapping. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
initiating a collection of probe data associated with a road segment based on detecting a road obstruction on the road segment;
processing the probe data to generate a time space diagram (TSD), wherein the TSD plots the probe data according to distance from an origin point on the road segment over time;
determining an intensity of the road obstruction based on the TSD;
determining a diversion confidence for diverting a route from the road segment based on the intensity; and
providing the diversion confidence as an output.

2. The method of claim 1, further comprising:
configuring a vehicle to divert around the road segment based on the diversion confidence.

3. The method of claim 2, wherein the vehicle is an autonomous vehicle.

4. The method of claim 1, further comprising:
determining an intensity weight based on the intensity of the road obstruction,
wherein the diversion confidence is further based on the intensity weight.

5. The method of claim 1, further comprising:
determining a detection weight of the road obstruction based on the sensor data used for the detecting of the road obstruction,
wherein the diversion confidence is further based on the detection weight.

6. The method of claim 5, wherein the detection weight is a fixed value.

7. The method of claim 1, further comprising:
configuring a vehicle to divert around the road segment based on determining that the diversion confidence is greater than a threshold confidence.

8. The method of claim 1, further comprising:
transmitting an alert message indicating the road obstruction to one or more vehicles within a predetermined proximity of the road segment.

9. The method of claim 8, wherein the alert message is transmitted based on determining that the diversion confidence is above a threshold confidence.

10. The method of claim 1, further comprising:
initiating a presentation of an alert message indicating the road obstruction to a passenger of a vehicle traveling within a predetermined proximity of the road segment without diverting the vehicle around the road segment based on determining that the diversion confidence is below a threshold confidence.

11. The method of claim 1, wherein the intensity is classified according to one or more classes, and wherein the one or more classes are associated with a respective intensity weight for determining the diversion confidence.

12. The method of claim 1, further comprising:
converting the TSD to an image; and
processing the image using a trained machine learning model to determine the intensity, the diversion confidence, or a combination thereof.

13. An apparatus comprising:
at least one processor; and
at least one memory including computer program code for one or more programs,
the at least one memory and the computer program code configured to, with the at least one processor, cause the apparatus to perform at least the following,
receive probe data associated with a road segment;
process the probe data to generate a time space diagram (TSD);
determine an intensity of the road obstruction based on the TSD;
determine a diversion confidence for diverting a route from the road segment based on the intensity; and
provide the diversion confidence as an output.

14. The apparatus of claim 13, wherein the apparatus is further caused to:
configure a vehicle to divert around the road segment based on the diversion confidence.

15. The apparatus of claim 13, wherein the vehicle is an autonomous vehicle.

16. The apparatus of claim 13, wherein the apparatus is further caused to:
determining an intensity weight based on the intensity of the road obstruction,
wherein the diversion confidence is further based on the intensity weight.

17. A non-transitory computer-readable storage medium carrying one or more sequences of one or more instructions which, when executed by one or more processors, cause an apparatus to perform:
receiving probe data associated with a road segment;
processing the probe data to generate a time space diagram (TSD);
determining an intensity of the road obstruction based on the TSD;
determining a diversion confidence for diverting a route from the road segment based on the intensity; and
providing the diversion confidence as an output.

18. The non-transitory computer-readable storage medium of claim 17, wherein the apparatus is further caused to:
configure a vehicle to divert around the road segment based on the diversion confidence.

19. The non-transitory computer-readable storage medium of claim 17, wherein the vehicle is an autonomous vehicle.

20. The non-transitory computer-readable storage medium of claim 17, wherein the apparatus is further caused to:
determining an intensity weight based on the intensity of the road obstruction,
wherein the diversion confidence is further based on the intensity weight.
